(19) United States
(12) Patent Application Publication
(10) Pub. No.: US 2008/0145485 A1
(43) Pub. Date: Jun. 19, 2008

(54) ROLLED PET TREAT AND PROCESS FOR MAKING SAME

(76) Inventors: Jacob Tepper, Boca Raton, FL (US); Steven Mendal, New York, NY (US); Dean Triandafellos, Freehold, NJ (US)

Correspondence Address: GREENBERG TRAURIG, LLP, 200 PARK AVE., P.O. BOX 677, FLORHAM PARK, NJ, 07932, US

(21) Appl. No.: 11/870,111

(22) Filed: Oct. 10, 2007

Related U.S. Application Data
(60) Provisional application No. 60/850,569, filed on Oct. 10, 2006.

(51) Int. Cl. A23K 1/00

(52) U.S. Cl. 426/92; 426/272

(57) ABSTRACT

A pet treat includes an outer layer of meat and an inner layer of rawhide that has been flavored with meat. An intermediate layer of glutin is formed during the manufacturing process and affixes the outer layer of meat to the inner layer of rawhide. The manufacturing process involves freezing the meat and then adding slices of the frozen meat on a rawhide roll such that the frozen meat substantially covers the circumference of the rawhide roll. During the dehydration step that is performed for a long period of time, the rawhide and the glutin are flavored by liquid seeped from the meat.

### CROSS-REFERENCE TO RELATED APPLICATION

This application claims the benefit of U.S. Provisional Patent Application No. 60/850,569 filed Oct. 10, 2006, the disclosure of which is incorporated herein by reference in its entirety.

### FIELD OF THE INVENTION

The present invention relates to pet treats and to a process for making same.

### BACKGROUND OF THE INVENTION

It is well known that chewing provides numerous health benefits to pets. For example, chewing allows pets to exercise their jaws. Chewing also promotes teeth cleaning, thereby reducing plaque and tartar buildup.

In an effort to realize the foregoing benefits, pet treats have been developed to promote chewing over an extended period of time. These pet treats are commonly made with pure rawhide. However, such rawhide pet treats are typically dry and lack substantial flavor, and are therefore unappealing to pets.

Some rawhide pet treats are coated with flavorings in an attempt to improve their palatability. Because the coatings are only applied to the outer layer of such rawhide pet treats, the remaining (i.e., uncoated) portions of these treats still lack substantial flavor. As a result, pets rapidly consume the coated outer layer, and then do not chew on the remaining portions of the treat. Accordingly, pets tend to chew on rawhide pet treats for only a relatively short period of time. In addition, the coated rawhide pet treat can stain carpets and other items inside a house. Thus, coated rawhide pet treats are suitable only for outdoor consumption.

Another type of pet treat is made with pure meat. While these pet treats may be palatable, they are rapidly consumed and therefore do not promote chewing for an extended period of time.

### SUMMARY OF THE INVENTION

The present invention overcomes the disadvantages and shortcomings of the prior art discussed above by providing a new and improved pet treat. More particularly, the pet treat includes an outer layer of meat, which is highly palatable. The pet treat also includes an inner layer of rawhide that has been flavored with meat, thereby improving the palatability of the rawhide. An intermediate layer of glutin is formed during the manufacturing process and affixes the outer layer of meat to the inner layer of rawhide. Thus, the pet treat provides two separate treats, which can be consumed indoors or outdoors.

A new and improved process for preparing the pet treat is also provided. The process includes mixing meat with additives so as to form a meat/additive mixture and freezing the meat/additive mixture. Slices of the frozen meat/additive mixture are added on a rawhide roll such that the frozen meat/additive mixture substantially covers the circumference of the rawhide roll and the meat/rawhide mixture is roasted for more than fifteen hours at a temperature of from about 65 degrees Celsius to about 85 degrees Celsius. During the dehydration step that is performed for a long period of time, the rawhide and the glutin are flavored by liquid seeped from the meat.

### BRIEF DESCRIPTION OF THE DRAWINGS

For a more complete understanding of the present invention, reference is made to the following detailed description of an exemplary embodiment of the present invention considered in conjunction with the accompanying drawings, in which:

FIG. 1 is a perspective view of a pet treat which has been prepared in accordance with one exemplary embodiment of the present invention;

FIG. 2 is a cross-sectional view, taken along section line 2-2 and looking in the direction of the arrows, of the pet treat shown in FIG. 1; and

FIG. 3 is a cross-sectional view, taken along section line 3-3 and looking in the direction of the arrows, of the pet treat shown in FIG. 1.

### DETAILED DESCRIPTION OF THE INVENTION

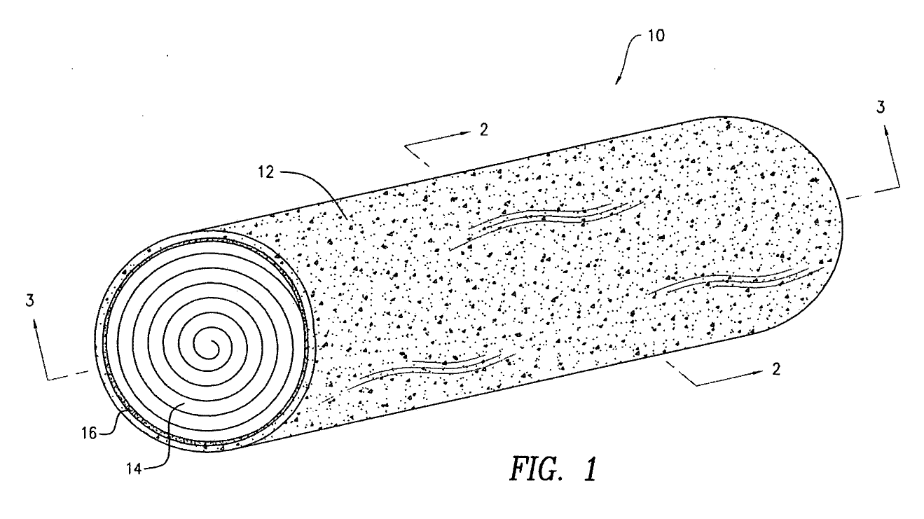

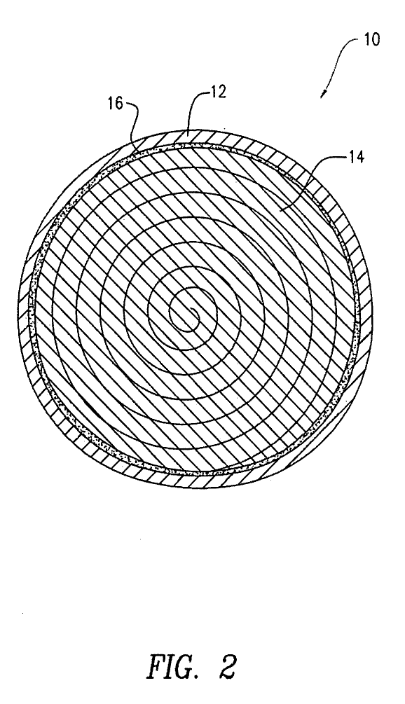

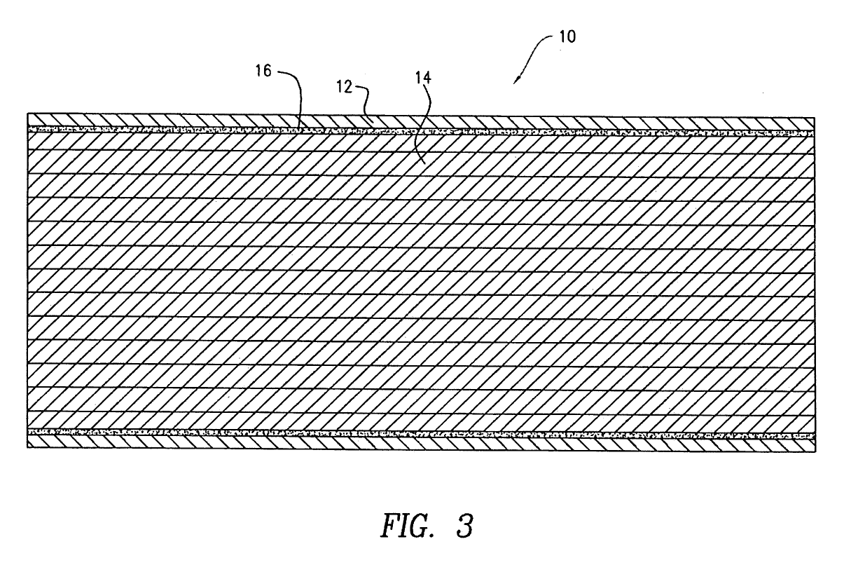

FIGS. 1-3 illustrate a pet treat 10 including an outer layer 12 made of meat and an inner layer 14 made of rawhide that has been flavored with meat during the manufacturing process. As used hereinafter, the term “meat” could include, but is not limited to, chicken, beef, pork, lamb, turkey, fish, any other animal meat, or a combination of animal meats.

With continued reference to FIGS. 1-3, the pet treat 10 also includes an intermediate layer 16 made of glutin formed between the outer layer 12 of meat and the inner layer 14 of flavored rawhide. More particularly, the intermediate layer 16 of glutin is formed from rawhide and flavored with meat during the manufacturing process, as will be described in further detail hereinafter. The intermediate layer 16 of flavored glutin serves to affix the outer layer 12 of meat to the inner layer 14 of flavored rawhide.

The pet treat 10 has a cylindrical shape, but it is understood that the pet treat 10 can have other shapes, such as a bone-shape, heart-shape, cubic, a rectangular prism, polyhedron, etc. The inner layer 14 of flavored rawhide is rolled in order to form the cylindrical shape, but it is understood that the inner layer 14 does not have to be rolled.

The process for preparing the pet treat 10 involves a first step of allowing frozen meat to thaw naturally. The thawed meat is then cleaned out thoroughly by performing two separate steps. More particularly, the first cleaning step involves washing the meat with a disinfecting agent, such as potassium or sodium hypochlorite water, in order to reduce the microbial content of the meat. An amount of 100 ppm potassium or sodium hypochlorite water can be used. The second cleaning step involves washing the meat with pure water.

The next step involves mixing the meat with the following additives: 1% to 1.2% of sugar, 0.6% to 1% of salt, 0.1% to 0.15% of potassium sorbate, and 0.04% to 0.1% of araboascorbic acid. It will be understood that all of these percentages are provided on a weight basis. With this in mind, it should be apparent that the quantity of each additive can be varied without departure from the present invention.

Sugar and salt are added to improve the palatability of the meat. Potassium sorbate and araboascorbic acid serve as antiseptic agents. Araboascorbic acid also functions to brighten the color of the meat.

After the meat is mixed with the additives, the meat/additive mixture is ground or wrung into a paste. Any conventional grinder may be used for this grinding step. Such grinders are known to those having ordinary skill in the art and are available from commercial sources.

The meat/additive mixture is placed onto a conventional stainless steel cubic tray and frozen at a temperature of from about 28 degrees Celsius below zero to about 25 degrees Celsius below zero for about 10 to 15 hours. The frozen meat/additive mixture is then cut into slices such that each slice has a thickness of 0.08 to 0.47 inches, a length of 3 to 7 inches, and a width of 0.39 to 1.97 inches. It will be understood that the above dimensions for each slice of the frozen meat/additive mixture are merely exemplary and that each slice can have other dimensions.

Slices of the meat/additive mixture are then positioned evenly on the circumference of a rawhide roll such that the meat/additive mixture completely covers the circumference of the rawhide roll, so as to form a combined product which includes the meat/additive mixture and the rawhide roll. When so positioned, the rawhide roll absorbs liquid from the meat/additive mixture such that the outer circumferential surface of the rawhide roll is soaked with liquid.

The combined product is then placed onto a conventional stainless steel shelf and roasted in a conventional drying house for an extended period of time, such as more than 15 hours at a temperature of from about 65 degrees Celsius to about 85 degrees Celsius until its moisture content is reduced to less than about 14%. After the temperature in the drying house reaches more than approximately 60 degrees Celsius for more than 2 hours, the soaked outer surface of the rawhide roll is sufficiently converted to a layer of glutin. Because glutin is a viscous material, it binds the slices of the meat/additive mixture to the rawhide roll.

During the drying step, the rawhide roll is flavored by liquid seeped from the meat, thereby enhancing the palatability and scent of the rawhide roll, as well as reducing the hardness of the rawhide roll, which makes the rawhide roll more chewable and appealing. Likewise, the glutin that is formed during the drying step is flavored by liquid seeped from the meat, thereby enhancing the palatability of the glutin, which makes the glutin appealing. Because the combined product is roasted for more than 15 hours, the rawhide roll and the glutin are flavored with liquid seeped from the meat for a long period of time.

The dried combined product is then sterilized with ozone for approximately two hours. Lastly, the dried combined product is irradiated at a minimum dose on the order of 7 kGy.

Referring to FIGS. 1-3, the pet treat 10 that results from the foregoing process contains an inner layer 14 of flavored rawhide, an intermediate layer 16 of flavored glutin, and an outer layer 12 of meat. The ratio of meat to rawhide can vary. In one embodiment, the ratio of meat to rawhide is approximately 30 to 70 by weight and/or by volume. The intermediate layer 16 of flavored glutin is thinner than the outer layer 12 of meat and/or the inner layer 14 of flavored rawhide.

It should be appreciated that the pet treat 10 provides numerous advantages over the prior art pet treats described above. Because the outer layer 12 of the pet treat 10 includes meat, which is highly palatable, soft, and chewable, the pet treat 10 is initially attractive to pets. As the pet chews on the outer layer 12 of meat and consumes the outer layer 12 of meat, the pet will grind and scrape its teeth against the inner layer 14 of flavored rawhide through the intermediate layer 16 of flavored glutin. Such grinding and scraping clean the teeth of the pet, thereby reducing plaque and tartar buildup, as well as providing jaw exercise for the pet.

The improved flavor, scent, and softness of the rawhide encourage the pet to chew on the inner layer 14 of the flavored rawhide after the outer layer 12 of meat is consumed. As a result, the pet will continue to grind and scrape its teeth against the inner layer 14 of flavored rawhide.

As is evident from the description above, the pet treat 10 produced from the foregoing process is chewed for an extended period of time relative to pet treats that include only meat or rawhide. The highly palatable meat and the improved flavor of the rawhide cause the pet to maintain interest in the pet treat 10 until it is substantially or totally consumed. The pet treat 10 is suitable for indoor or outdoor consumption. The rawhide also functions as a support to maintain the shape of the pet treat 10.

It should be noted that the present invention can have numerous modifications and variations. For instance, the process could involve placing the frozen meat/additive mixture and the rawhide roll into a conventional molding machine, and then compressing the mold in a conventional manner to form a molded product which includes a combination of the meat/additive mixture and rawhide roll. The step of cutting the frozen meat/additive mixture into slices can be eliminated if a molding step is utilized.

Although the present invention is described in connection with a rawhide roll, it should be understood that the present invention can be used with other rawhide products, such as a knotted bone, rawhide ear, rawhide doughnut, rawhide turkey leg, rawhide cane, etc. The rawhide can be replaced by any animal skin, such as pork skin. The rawhide can be natural or reformed. The inner layer 14 of the pet treat 10 can include other animal body parts, such as tracheas, tendons, pig ears, tails, hoofs, and bones, which could be knotted or compressed. The rawhide can be twisted or knotted. Pure meat, without any additives, can be placed on the rawhide, thereby eliminating the need for a grinding step. All such variations and modifications are intended to be included within the scope of the invention as defined by the appended claims.

What is claimed is:

1. A method for making a pet treat, comprising the steps of:
adding frozen meat on a rawhide roll such that the meat substantially covers the circumference of the rawhide roll; and
roasting the meat/rawhide mixture so as to convert the top surface of the rawhide roll to a layer of glutin, thereby forming an outer layer of meat, an intermediate layer of glutin, and an inner layer of rawhide.

2. The method of claim 1, wherein the step of adding frozen meat comprises:
freezing the meat at a temperature of from about 28 degrees Celsius below zero to about 25 degrees Celsius below zero for about 10 hours to about 15 hours;
cutting the meat into slices; and
positioning the slices of the meat on the rawhide roll such that the meat substantially covers the circumference of the rawhide roll.

3. The method of claim 2, wherein the meat/rawhide mixture is roasted for more than fifteen hours at a temperature of from about 65 degrees Celsius to about 85 degrees Celsius until the moisture content of the meat/rawhide mixture is reduced to less than about 14%.

4. The method of claim 3, further comprising the step of mixing meat with additives so as to form a meat/additive mixture.

5. The method of claim 4, wherein the step of mixing meat with additives comprises mixing meat with sugar, salt, potassium sorbate, and araboascorbic acid.

6. The method of claim 5, wherein the step of mixing meat with additives comprises mixing meat with 1% to 1.2% of sugar, 0.6% to 1% of salt, 0.1% to 0.15% of potassium sorbate, and 0.04% to 0.1% of araboascorbic acid.

7. The method of claim 6, further comprising the steps of washing the meat with a disinfecting agent and washing the meat with water.

8. The method of claim 7, further comprising the steps of sterilizing the meat/rawhide mixture with ozone and irradiating the meat/rawhide mixture.

9. The method of claim 1, wherein the ratio of meat to rawhide is approximately 30 to 70 by weight.

10. The method of claim 1, wherein the ratio of meat to rawhide is approximately 30 to 70 by volume.

11. A pet treat, including an outer layer of meat and an inner layer of flavored rawhide, wherein the pet treat is made in accordance with a method comprising the following steps:
mixing meat with additives so as to form a meat/additive mixture;
freezing the meat/additive mixture;
adding slices of the frozen meat/additive mixture on a rawhide roll such that the frozen meat/additive mixture substantially covers the circumference of the rawhide roll; and
roasting the meat/additive/rawhide mixture.

12. The pet treat of claim 11, wherein the meat/additive/rawhide mixture is roasted for more than fifteen hours at a temperature of from about 65 degrees Celsius to about 85 degrees Celsius so as to convert the top surface of the rawhide roll to a layer of glutin, thereby forming an intermediate layer of glutin between the outer layer of meat and the inner layer of rawhide.

13. The pet treat of claim 11, wherein the additives include sugar, salt, potassium sorbate, and araboascorbic acid.

14. The pet treat of claim 11, wherein the meat comprises chicken.

15. A method for making a pet treat, comprising the steps of:
mixing meat with additives so as to form a meat/additive mixture;
freezing the meat/additive mixture;
adding slices of the frozen meat/additive mixture on a rawhide roll such that the frozen meat/additive mixture substantially covers the circumference of the rawhide roll; and
roasting the meat/additive/rawhide mixture for more than fifteen hours at a temperature of from about 65 degrees Celsius to about 85 degrees Celsius.
